(19) United States
(12) Patent Application Publication
(10) Pub. No.: US 2010/0186906 A1
(43) Pub. Date: Jul. 29, 2010

(54) Device for driving and turning the slats of a Venetian blind

(76) Inventors: Franz Kraler, Abfaltersbach (AT); Eugen Karg, Bergholen (DE)

Correspondence Address: NOTARO, MICHALOS & ZACCARIA P.C., 100 DUTCH HILL ROAD, ORANGEBURG, NY, 10962, US

(21) Appl. No.: 12/693,136

(22) Filed: Jan. 25, 2010

(30) Foreign Application Priority Data
Jan. 27, 2009 (AT) A 133/2009

(51) Int. Cl. E06B 9/32

(52) U.S. Cl. 160/168.1 P; 160/405

(57) ABSTRACT

A device for driving and turning the slats of a Venetian blind, with a bearing housing which is embodied for rotatably receiving a drivable drive shaft penetrating the bearing housing, a winding spool for a carrier band, a turning mechanism for tilting the slats and an abutment flange for fixing angular end positions for the slats, the turning mechanism for moving the slats between defined angular end positions and also for arresting the slats in an angular intermediate position comprising at least one turning element and an abutment element which can be brought releasably into engagement with the turning element by means of an actuating mechanism, the drive and turning device for arresting the slats being arranged and embodied in an angular intermediate position during raising of the Venetian blind, the actuating mechanism acting on the abutment element being embodied so as to run freely in a direction of rotation of the drive shaft.

The invention relates to a device for driving and turning the slats of a Venetian blind, with a bearing housing which is embodied for rotatably receiving a drivable drive shaft penetrating the bearing housing, a winding spool for a carrier band, a turning mechanism for tilting the slats and an abutment flange for fixing angular end positions for the slats, the turning mechanism for moving the slats between defined angular end positions and also for arresting the slats in an angular intermediate position comprising at least one turning element and an abutment element which can be brought releasably into engagement with the turning element by means of an actuating mechanism.

Venetian blinds with a drive and turning device are generally known, for example from WO 2004/059 117 A1 or EP 10 52 365 B1. In this case, what is known as the working position, in which the slats are arrested in an intermediate angular position, allows the Venetian blinds to be lowered in a state other than in the closed state.

The generic drive and turning devices known in the art are based on the common idea of offering the user a Venetian blind, the slats of which not only can be swiveled between two angular end positions—one for lowering, one for raising—but in addition are arrestable during lowering of the Venetian blinds in an angular intermediate position in which the Venetian blind is in a practical half-open state.

Starting from this prior art, the object of the invention is to provide a novel device for driving and turning the slats of a Venetian blind allowing the user to arrest the slats in various angular positions in a convenient and versatile manner.

In order to achieve this object, the invention provides for the drive and turning device for arresting the slats to be arranged and embodied in an angular intermediate position during raising of the Venetian blind, the actuating mechanism acting on the abutment element being embodied so as to run freely in a direction of rotation of the drive shaft.

The invention thus pursues a completely new solution approach. Whereas the prior art took as its starting point for increasing ease of operation in each case Venetian blinds packed above the opening from which light is to be shut out and all the proposals for improvement have therefore related to the position of the slats during lowering of the Venetian blind, the invention assumes that the Venetian blind is moved in the morning or at the beginning of a working day from the lowered to the raised state, so that an angular intermediate position for the slats is actually required during raising of the Venetian blind.

According to a preferred exemplary embodiment of the invention, provision may in this case furthermore be made for the drive and turning device to have an actuating element, which can be brought into operative connection to the turning mechanism, for arresting the slats in a working position during lowering of the Venetian blind.

In other words, in this exemplary embodiment, four angular positions are provided for the slats, the slats being swiveled between two angular end positions and arrestable in two different angular intermediate positions which are positioned between the angular end positions and of which one angular intermediate position is assumed during lowering of the Venetian blind and the other angular intermediate position is assumed during raising of the Venetian blind.

An embodiment of this type therefore provides the operator with a drive and turning device which is much more versatile and convenient to operate.

A simply constructed solution provides in this case for the actuating mechanism to be constantly engaged with the abutment element of the turning mechanism.

According to a further exemplary embodiment of the invention, the actuating mechanism has at least one actuating part which is rotatably mounted in the axis of rotation of the drive shaft and also a free-running element which is operatively connected or operatively connectable to the actuating part.

According to a further exemplary embodiment of the invention, for fixing the slats in a working position during raising of the Venetian blind, provision is made for a coupling element, by means of which the actuating part and the free-running element for arresting the slats in an angular intermediate position during raising of the Venetian blind can be brought releasably into engagement, to be arranged between the actuating part and the free-running element.

According to a simply constructed solution, provision is in this case made for the coupling element to be formed by a spiral spring. It goes without saying that the coupling element can also be formed by a differently embodied force accumulator.

According to a further embodiment of the invention, provision may be made for the actuating part to be embodied in a sleeve-shaped manner, an end portion of the sleeve-shaped actuating part being non-rotatably connected to the free-running element and the actuating part having in its opposing end portion an abutment pin for engaging with the abutment element. It has proven beneficial if the abutment pin, viewed from the side, is arranged on the actuating part so as to protrude axially on the end side.

According to a further exemplary embodiment of the invention, the free-running element, which is mounted so as to be able to rotate about the axis of rotation of the drive shaft, is embodied in a substantially disk-shaped manner and has on its outer circumferential surface a guide groove in which a sliding part, which is arranged in the bearing housing so as to be linearly movable, is guided.

In order to ensure a free run for the sliding part in a direction of rotation of the drive shaft, provision is in this case furthermore made for the guide groove to run helically and be embodied in an end portion as a peripheral guide channel without an inclination.

Although different means can be used to transmit the rotary movement of the drive shaft to the free-running element of the actuating mechanism, an embodiment of the invention provides for the rotary movement of the drive shaft to be transmitted to the free-running element of the actuating mechanism by means of a planetary gear.

For production-related reasons and in order to ensure a simple possibility for maintenance or an exchange if required, a further exemplary embodiment of the invention provides for at least the actuating mechanism to be arranged and embodied in a separate bearing part which is releasably connectable to the bearing housing.

According to the invention, provision may furthermore be made for the abutment element of the turning mechanism to be embodied in a disk-shaped manner, a stop element for engaging with the abutment flange and means for engaging with the actuating part of the actuating mechanism being arranged or embodied on the side of the abutment element that is remote from the turning element. A simply constructed solution provides for the means to be formed by a guide track in which the actuating part is guided.

In particular in a coaxial arrangement of the various drive and turning devices on a drivable drive shaft, it has proven beneficial if the guide track is embodied as an arc of a circle-shaped through-opening.

In particular if the drive and turning device has an actuating element, which can be brought into operative connection to the turning mechanism, for arresting the slats in a working position during lowering of the Venetian blind, it has proven advantageous in the sense of a simply constructive solution if the actuating element can be brought into operative connection to the abutment element of the turning mechanism by means of the sliding part of the actuating mechanism.

In order to be able to keep down the longitudinal extension of the bearing housing, which is generally embodied in a substantially cylindrical manner, a further exemplary embodiment of the invention provides for at least the winding spool, the turning mechanism, the abutment flange and the actuating element to be arranged in a common bearing housing. It has proven beneficial if the bearing housing, which has at least the winding spool, the turning mechanism, the abutment flange and the actuating element, is releasably connectable to the bearing part having the actuating mechanism.

According to a further embodiment of the invention, the actuating element is in this case movable between an engagement position, arresting the abutment element in an angular intermediate position, and a release position, whereas the second angular intermediate position for arresting the slats is assumed during raising of the Venetian blind by means of the actuating part and the free-running element of the actuating mechanism.

According to a further embodiment of the invention, provision is made for the actuating element to have a basic element and at least two engagement elements which are arranged thereon and of which a first engagement element is operatively connected or can be brought into operative connection to the turning mechanism and/or a second engagement element is operatively connected or can be brought into operative connection to the lost motion mechanism.

In order to be able to bring the first or the second engagement element of the actuating element into operative connection to the turning mechanism or the lost motion mechanism, it is necessary to change the position of the actuating element in the bearing housing. For this purpose, according to a preferred exemplary embodiment of the invention, provision is made for the actuating element to be movable between the release and engagement positions by converting a rotational movement of the drive shaft into an axial movement in the direction of the axis of rotation. A reliable mode of operation can be achieved when the actuating element is free from the loading of a force accumulator, in particular spring loading, at least during the movement between the release and engagement positions, and vice versa.

In contrast to the prior art, in which this movement of the actuating element is achieved precisely by loading by means of a force accumulator, in the invention the actuating element is switched between the release and input positions by rotating the drive shaft, as a result of which, on the one hand, malfunctions which can occur when using resilient force accumulators are avoided and, on the other hand, a solution is provided that is gentle on the material.

The invention further relates to a device for driving and turning the slats of a Venetian blind, with a bearing housing in which at least one winding spool for a carrier band and a turning mechanism for tilting the slats between defined angular end positions by means of a drive shaft are rotatably mounted, and an actuating element, which can be brought into operative connection to the turning mechanism, for arresting the slats in a working position during lowering of the Venetian blind, the actuating element being movable between an engagement position, arresting the abutment element in an angular intermediate position, and a release position.

In the solutions known in the art, the construction arrangement of the lost motion mechanism and the actuating element in a separate add-on module necessitates loading the actuating element by means of a resilient force accumulator in order to ensure that the actuating element is switched between the engagement and release positions. Apart from the increased space required therefor, this arrangement of an additional force accumulator also has an adverse effect on the manufacturing costs of a Venetian blind bearing with a working position function.

In order to bypass these problems, a further exemplary embodiment of the invention therefore provides for the actuating element to be arranged in the bearing housing so as to be movable substantially parallel to the axis of rotation R, the actuating element being moved between the release and engagement positions by means of the turning mechanism.

The arrangement of an additional force accumulator loading the actuating element is therefore dispensed with and the necessary movement of the actuating element is ensured in a simple manner by the turning mechanism which is present anyway.

For this purpose, a preferred embodiment of the invention provides for the actuating element to be arranged in the bearing housing so as to be able to swivel substantially parallel to the axis of rotation R. It has proven beneficial if the actuating element is mounted on the bearing housing so as to be able to swivel about an axis which is substantially normal to the axis of rotation R.

This preferred swivelable arrangement of the actuating element in the bearing housing allows a particularly short construction and is, on account of the rotatory mounting of the actuating element, a particularly smooth-running variant.

According to an alternative embodiment of the invention, provision is made for the actuating element to be arranged in the bearing housing so as to be displaceable linearly, substantially parallel to the axis of rotation R. A continuously guided, translatory movement can be achieved when a guide element, by means of which the actuating element is guided so as to be linearly displaceable in a corresponding guide embodied on the bearing housing, is arranged or embodied on the actuating element. It has proven beneficial if the guide is formed by a through-opening formed in the wall of the bearing housing.

According to a further exemplary embodiment of the invention, provision is furthermore made for the abutment element of the turning mechanism to be embodied in a disk-shaped manner and to have on its outer circumferential surface at least one deflecting element and an arresting element which interact with the actuating element, secure interlocking of the actuating element on the abutment element being achieved when the arresting element is embodied in a v-shaped manner.

As a result of a formation of this type of the circumferential surface of the abutment element, the abutment element can serve not only to arrest, as in the prior art, the slats in an angular intermediate position but, in addition, to cause the movement of the actuating element between the release and engagement positions and vice versa.

For this purpose, according to a further exemplary embodiment of the invention, provision is made for the actuating element to be driven by means of a wheel and shaft during its movement between the release and engagement positions, the shaft of the wheel and shaft being formed by the drive shaft and the wheel of the wheel and shaft being formed by the abutment element of the turning mechanism and the rotational movement of the abutment element being converted into a movement of the actuating element that is axial to the axis of rotation R substantially by means of the at least one deflecting element arranged on the circumferential surface of the abutment element.

In other words, the engagement elements of the actuating element on the circumferential surface of the abutment element are therefore moved back and forth substantially linearly in the axial direction of the drive shaft as a function of the direction of rotation of the drive shaft.

A further exemplary embodiment of the invention provides for the abutment flange to be embodied, as is known per se, for receiving a plurality of abutment pins in different site positions, the different site positions each defining different angular end positions.

The invention further relates to a Venetian blind with a drive and turning device according to the invention which is distinguished by a raising working position for the slats during raising of the Venetian blind in which the slats are arrested or arrestable in an angular intermediate position positioned between two angular end positions.

According to a further embodiment, a preferred exemplary embodiment of a Venetian blind of this type is characterized by at least two working positions for the slats, of which a first, lowering working position can be assumed during lowering of the Venetian blind and a second, raising working position can be assumed during raising of the Venetian blind, the two working positions being fixed by two different angular intermediate positions positioned between the two angular end positions.

The invention seeks further to disclose a method for swiveling the slats of a Venetian blind as claimed in one of claim 33 or 34, in which the slats are arrestable during raising of the Venetian blind in an angular intermediate position positioned between two angular end positions.

According to the innovation, provision is in this case made for, during raising of the Venetian blind from the lowered position, the slats to be in a first step turned inward until the free-running element of the actuating mechanism is blocked by means of the sliding part, as a result of which the direction of rotation of the sun wheel of the planetary gear is reversed and, on further rotation of the drive shaft, the turning element is moved via the coupling element and the actuating part, which is engaged with the abutment element, in a direction of rotation opposite to the direction of rotation of the drive shaft until the actuating part is blocked in the bearing part, as a result of which, on further rotation of the drive shaft, the slats are swiveled into the second angular intermediate position and remain therein until the next reversal of the direction of rotation of the drive shaft.

Further advantages and details of the invention will be explained in greater depth based on the subsequent description of the figures with reference to the exemplary embodiments illustrated in the drawings, in which:

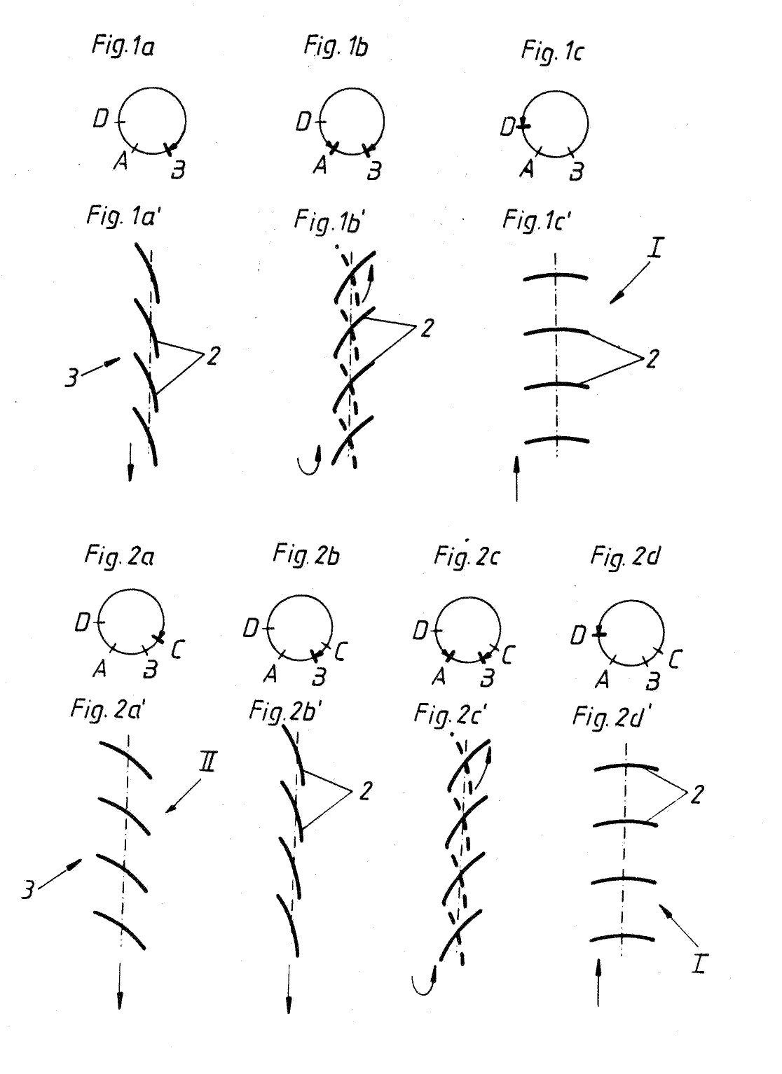

FIG. 1a to 1c′ show different positions of the slats during lowering and raising of the Venetian blind according to a first exemplary embodiment of the invention;

FIGS. 2a to 2d′ show different positions of the slats during lowering and raising of the Venetian blind according to a further exemplary embodiment of the invention;

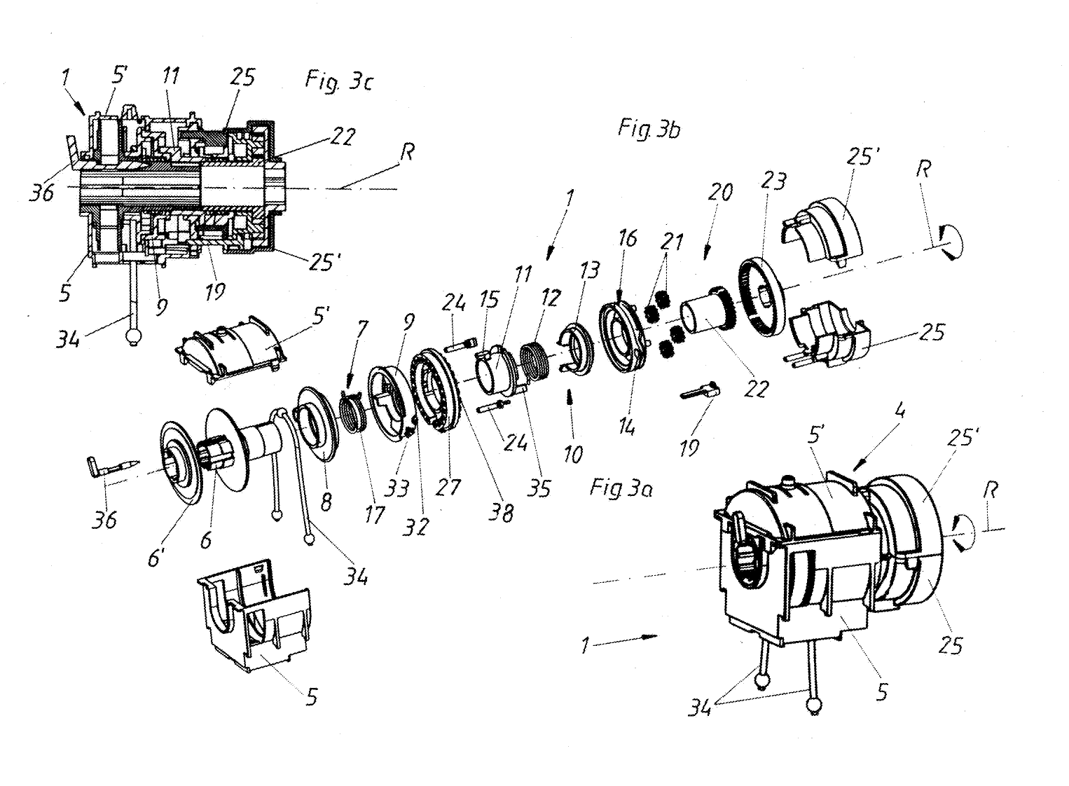

FIG. 3a is a perspective view of a drive and turning device according to the exemplary embodiment as shown in FIG. 1;

FIG. 3b is an exploded view of the exemplary embodiment according to FIG. 3a;

FIG. 3c is a longitudinal section through the exemplary embodiment according to FIG. 3a;

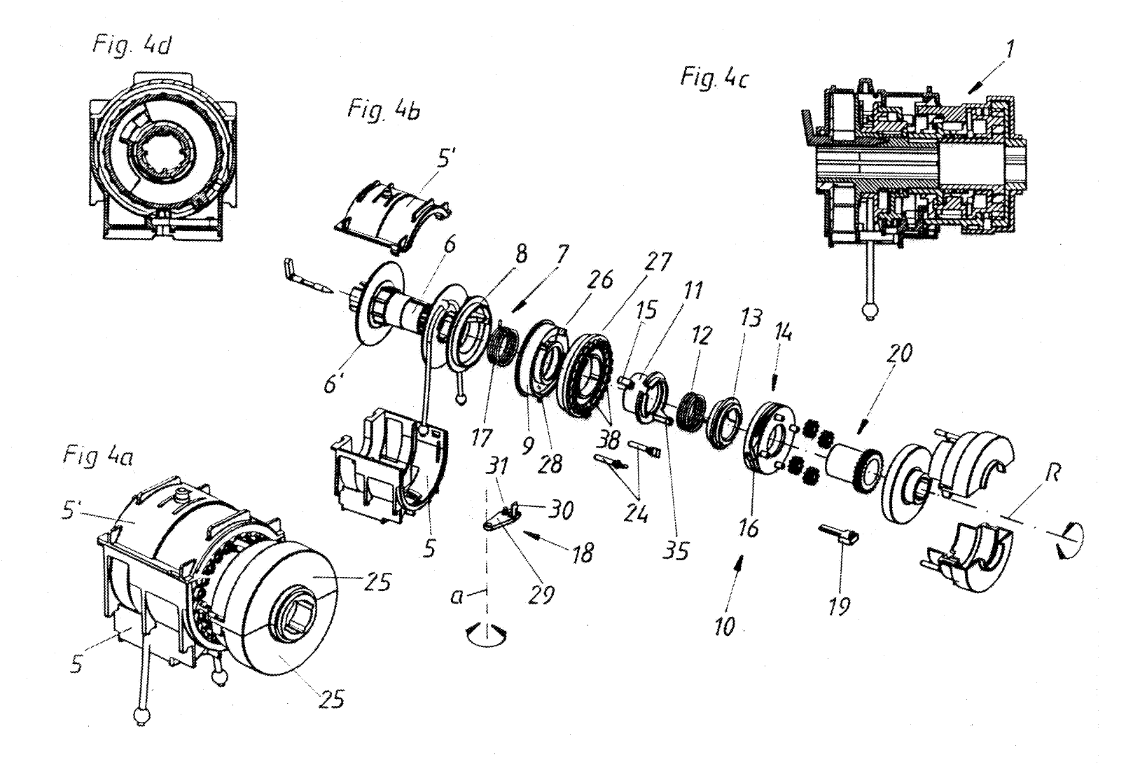

FIG. 4a is a perspective view of the drive and turning device according to FIG. 2;

FIG. 4b is an exploded view of the exemplary embodiment according to FIG. 4a;

FIG. 4c is a longitudinal section through the exemplary embodiment according to FIG. 4a;

FIG. 4d is a cross section along the sectional line SS′ from FIG. 4c; and

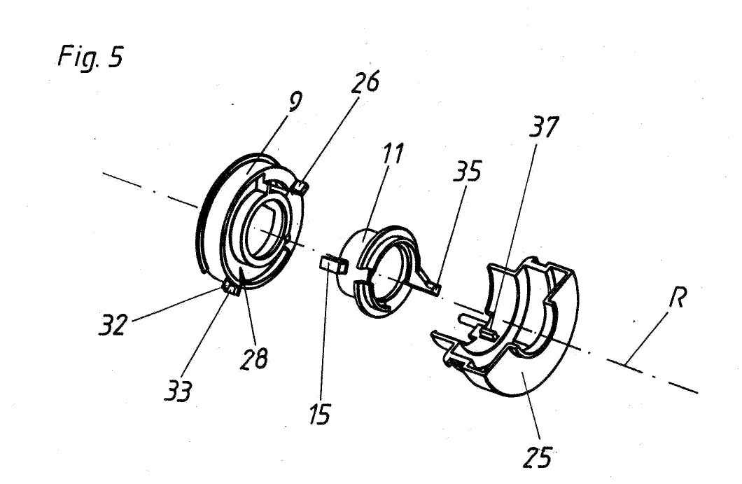

FIG. 5 shows in detail the abutment element, the actuating part and the lower half of the bearing part for the actuating mechanism.

FIG. 1 a to 1c′ show the functional principle of a Venetian blind bearing with a working position function during raising of the Venetian blind.

Whereas in conventional Venetian blinds 3 the slats 2 can be swiveled merely between two angular end positions A, B, the Venetian blinds generally being lowered in the closed state (angular end position B) and raised in the half-opened state (angular end position A), known drive and turning devices with a working position function have an angular intermediate position C (FIGS. 2a to 2d) which is positioned between the angular end positions A, B and in which the slats are arrestable in the opened state, usually opened approx. 50° outward, so that the Venetian blind can be lowered in this working position of the slats, that is to say with daylight streaming in.

The drive and turning device according to the invention differs from this prior art in terms of an angular intermediate position D which is positioned between the angular settings A, B and in which the slats are arrestable in the opened state, in a roughly horizontal position, so that the Venetian blind can be raised in this working position I of the slats.

FIG. 1a and 1a′ show the lowering of the Venetian blind 3 in the closed state, that is to say the slats 2 are at angular setting B.

For raising the Venetian blind, the slats 2 of the Venetian blind 3 are, as illustrated in FIGS. 1b, 1b′, turned by changing the direction of rotation toward the left from the angular end position B to the angular end position A.

During further raising of the Venetian blind, that is to say the drive shaft is rotated toward the left, the direction of rotation of the drive for the actuating mechanism is changed, preferably using a free-running means, as a result of which the slats 2 are subsequently swiveled into the angular intermediate position D (FIGS. 1c, 1c′) so that, during further raising of the Venetian blind, the slats 2 are held in an open position corresponding to the angular intermediate position D.

It goes without saying that the invention is not limited to the illustrated angular intermediate position D corresponding to a roughly horizontal position of the slat. A basic idea of the invention consists in providing the user with a Venetian blind, the slats of which can be arrested during raising substantially between the closed position (angular end position A) and the illustrated horizontal position.

In the exemplary embodiment shown in FIGS. 2a and 2d′, the Venetian blind additionally has a working position function II during lowering of the Venetian blind.

FIGS. 2a and 2a′ show this working position function II in which the slats 2 are held in the angular intermediate position C and the Venetian blind is lowered by way of the rotating drive shaft toward the right in the direction indicated by the arrow.

For completely closing the Venetian blind 3, the working position II, that is to say the arresting of the slats 2 in the angular intermediate position C, is firstly canceled by changing the direction of rotation of the drive shaft before the slats 2 are swiveled into the angular end position B by way of a further change in the direction of rotation via the angular intermediate position C, so that the Venetian blind is closed in its entirety (FIG. 2b, b′).

The functional principle and the mode of operation of FIGS. 2b to 2d′ correspond to the functional principle and the mode of operation of FIGS. 1a to 1c′ and differ therefrom only in terms of the angular intermediate position C, which does not play any part in the raising of the Venetian blind as shown in both FIGS. 1a to 1c′ and FIGS. 2b to 2d′, and will therefore not be described again.

FIG. 3a is a perspective view of a drive and turning device 1 according to the invention in which the Venetian blind bearing 4 has a bearing housing 5, 5′ and a bearing part 25, 25′. In terms of size, the bearing housing 5, 5′ corresponds in this case to a standard bearing according to the prior art without a working position function. In the exemplary embodiment shown, the bearing housing has a bearing body 5 and a bearing cover 5′ which are made from plastics material, in particular by injection molding, and can be connected to each other in a form-fitting manner. The bearing housing is embodied for rotatably receiving a drive shaft (not shown) which penetrates the bearing body 5 and is rotatable about the axis of rotation R.

From left to right, the winding spool 6, the turning mechanism 7 and also the abutment element 9 are—as may be seen from FIG. 3b—arranged in the bearing housing 5, 5′ coaxially with one another and so as to be able to rotate about the axis of rotation R.

The winding spool 6 is cylindrically embodied and has a disk-shaped, non-rotatably arranged flange and also a through-opening for the drive shaft. To the left of the disk-shaped flange, the spool disk 6′ is non-rotatably attached to the winding spool 6. The spool disk 6′ has, in addition to a through-opening for the drive shaft, a hole for receiving a carrier band pin 36 which serves to fasten the carrier band (not shown) to be wound up on the winding spool. On the right side of the disk-shaped flange, the turning element 8 and the abutment element 9 of the turning mechanism 7 are rotatably arranged on the winding spool 6. The turning spring 17 is arranged in a manner known per se between the turning element 8 and the abutment element 9. The turning string 34 is connected to the turning element 8 and the slots 2.

In the exemplary embodiment shown, the abutment flange 27, which is arranged on the right next to the abutment element 9, forms at the same time an end wall of the bearing housing 5, 5′ and is non-rotatably connected thereto.

The angular end positions A, B, between which the slats 2 are tiltable, can be defined by means of the abutment pins 24 which are inserted into through-openings 38 in the abutment flange 27.

In other words, an elongate winding spool 6, which is embodied in the form of a hollow shaft, is arranged in the bearing housing 5, 5′, one end side of which is formed by the abutment flange 27, the turning mechanism 7 being mounted on the hollow shaft-shaped winding spool 6 which is rotatable by means of the drive shaft.

The bearing part 25, 25′, in which the actuating mechanism 10, by means of which the slats 2 can be swiveled into a working position I during raising of the turning mechanism 7, is arranged, is releasably connected to the bearing housing 5, 5′.

As may be seen from FIGS. 3b and 3c, the actuating mechanism 10 comprises an actuating part 11 which is embodied in a sleeve-shaped manner and protrudes, in the assembled state of the drive and turning device 1, into the bearing housing 5, 5′ through a through-opening in the abutment flange 27 (FIG. 3c).

The free-running element 14 is operatively connected to the actuating part 11 via a coupling element 12, which is formed in the exemplary embodiment shown by a spiral spring, and a coupling ring 13. In this case, the free-running element 14 is brought by means of the coupling element 12 releasably into engagement with the actuating part 11 during raising of the Venetian blind 3, leading to an arresting of the slats 2 in the angular intermediate position D.

In the exemplary embodiment shown, the free-running element 14, which is mounted so as to be able to rotate about the axis of rotation R of the drive shaft, is embodied in a substantially disk-shaped manner and has on its outer circumferential surface a guide groove 16 in which a sliding part 19, which is arranged in the Venetian blind bearing 4 so as to be linearly movable, is guided. The guide groove 16 runs in this case helically, but is embodied in an end portion as a peripheral guide channel without an inclination in order to ensure a free run for the sliding part 19 in a direction of rotation.

Four star wheels 21 of a planetary gear 20, which interact with the sun wheel 22 and the hollow wheel 23 of the planetary gear 20, are arranged on the free-running element 14, on its end side remote from the actuating part 11. In other words, the first exemplary embodiment, as shown in FIGS. 1 and 3, of a drive and turning device according to the invention therefore has a standard bearing according to the prior art, which is arranged in a bearing housing 5, 5′ and does not have a working position function, and an actuating mechanism 10 which is arranged in a separate bearing part 25, 25′, which is releasably connectable to the bearing housing 5, 5′, and can be used to swivel and arrest the slats 2 into a working position I during raising of the Venetian blind.

The exemplary embodiment according to FIGS. 4a to 4d corresponds both in its construction and in its mode of operation to the exemplary embodiment according to FIGS. 3a to 3c and differs therefrom merely in terms of the presence of an actuating element 18 which in the exemplary embodiment shown is arranged in the bearing body 5 so as to be able to swivel about the axis of rotation a, which runs substantially normally to the axis of rotation R, and can be brought into engagement with the abutment element 9 of the turning mechanism 7 via the first engagement element 31 and with the sliding part 19 of the actuating mechanism 10 via the second engagement element 30.

The mode of operation is in this case as follows: During a rotation of the guide element 14, the sliding part 19, which is guided in the guide groove 16, is moved linearly in the direction of the bearing housing 5, 5′ until it abuts against the engagement element 30 of the actuating element 18, as a result of which the actuating element 18 is swiveled in such a way that the first actuating element 31 enters into engagement with the deflecting element 32 arranged on the outer circumferential surface of the abutment element 9 and is moved onward therefrom until it interlocks with the arresting element 33. During a further rotary movement of the drive shaft, the turning element 8 of the turning mechanism 7 is then arrested via the turning spring 17 and the abutment element 9, which is then stationary, in a position in which the slats 2 are in an angular intermediate position C corresponding to the working position II during lowering of the Venetian blind.

In FIGS. 4a to 4d like parts have been given the same reference numerals as in FIGS. 3a to 3c, and will therefore not be described again in detail.

The mode of operation of the actuating mechanism 10 for assuming a working position I of the slats 2 for raising the Venetian blind 3 is identical in both exemplary embodiments according to FIGS. 3 and 4 will be described hereinafter.

After canceling the arresting of the slats 2 in the angular intermediate position C, which corresponds to the working position II during lowering of the Venetian blind 3 (FIGS. 2a, 2a′), the curtain is dropped in its entirety, by rotating the drive shaft toward the right, until it is completely closed (FIGS. 2b, 2b′). In order now to raise the Venetian blind, the direction of rotation of the drive shaft is changed, that is to say the drive shaft rotates toward the left, the turning element 8 being entrained toward the left by means of the turning spring 17, so that the slats 2 are swiveled inward (FIGS. 2c, 2c′).

At the same time, the hollow wheel 23 drives the free-running element 14 via the star wheels 21 and the sun wheel 22. In this case, the sun wheel 22 is blocked by the abutment element 8, the actuating part 11 and the coupling element 12.

The free-running element 14 continues to rotate to the left until the cam, which is embodied on the sliding part 19 and guided in the guide groove 16 of the free-running element 14, blocks the rotary movement; in the exemplary embodiment shown, this is the case after approx. 1.5 revolutions.

During a further rotation of the drive shaft, the sun wheel 22 is rotated via the hollow wheel 23 and the star wheels 21 in a direction of rotation opposite to the direction of rotation of the drive shaft (toward the right) and entrains the coupling element 12 formed by a spiral spring.

The coupling element 12, for its part, entrains the actuating part 11 which is engaged with the abutment element 9 above the abutment pin 15. The actuating part 11 reverses the turning ring 8, counter to the turning spring 17, in the direction opposite to the direction of rotation of the drive shaft (toward the right) until the coupling element 12 or the coupling ring 13 abuts against the knob-shaped projection 37 located in the bearing part 25.

During a further rotation of the drive shaft toward the left, the slats are moved into the horizontal position, that is to say they are swiveled into the angular intermediate position D and arrested there (FIG. 2d, d′), and remain in this working position I until the next reversal of the direction of rotation of the drive shaft.

FIG. 5 illustrates, again in detail, the interplay of the abutment element 9 with the actuating part 11 and the bearing part 25. The abutment pin 15 arranged on the actuating part 11 is guided in the means 28, formed by a through-opening, of the abutment element 9, so that the actuating part 11 is constantly engaged with the abutment element 9. On its opposing end side, the actuating part 11 has an extension 35 which engages with the bearing part 25 and is operatively connected or can be brought into operative connection to the knob-shaped projection 37 arranged there.

Although the invention has been explained in depth based on the exemplary embodiments shown, it goes without saying that the subject-matter of the application is not limited to the illustrated exemplary embodiments. On the contrary, measures and modifications which serve to implement the idea of the invention are entirely conceivable and desired. Thus, for example, a lost motion mechanism could be arranged between the planetary gear and the actuating mechanism in order in this way to ensure that the slats are turned from the angular end position B into the angular intermediate position D (working position I) when the curtain is completely lowered, rather than the turning of the slats being carried out, as in the exemplary embodiments shown, during the first 1.5 revolutions as the Venetian blind is raised.

A basic idea of the invention consists in any case in providing a Venetian blind in which the slats are arrestable during raising of the curtain in an angular intermediate position located between the two angular end positions.

1. A device for driving and turning the slats of a Venetian blind, comprising:
a bearing housing which is embodied for rotatably receiving a drivable drive shaft penetrating the bearing housing,
a winding spool for a carrier band,
a turning mechanism for tilting the slats and
an abutment flange for fixing angular end positions for the slats,
wherein the turning mechanism for moving the slats between defined angular end positions and also for arresting the slats in an angular intermediate position comprising at least one turning element and an abutment element which can be brought releasably into engagement with the turning element by means of an actuating mechanism, wherein the drive and turning device is arranged and embodied for arresting the slats in an angular intermediate position during raising of the Venetian blind, the actuating mechanism acting on the abutment element being embodied so as to run freely in one direction of rotation of the drive shaft.

2. The drive and turning device as claimed in claim 1, wherein the drive and turning device has an actuating element, which can be brought into operative connection to the turning mechanism, for arresting the slats in a working position during lowering of the Venetian blind.

3. The drive and turning device as claimed in claim 1, wherein the actuating mechanism is constantly engaged with the abutment element of the turning mechanism.

4. The drive and turning device as claimed in claim 1, wherein the actuating mechanism has at least one actuating part, which is mounted so as to be able to rotate about the axis of rotation of the drive shaft, and also a free-running element which is operatively connected or operatively connectable to the actuating part.

5. The drive and turning device as claimed in claim 4, wherein a coupling element, by means of which the actuating part and the free-running element for arresting the slats in an angular intermediate position during raising of the Venetian blind can be brought releasably into engagement, is arranged between the actuating part and the free-running element.

6. The drive and turning device as claimed in claim 5, wherein the coupling element is formed by a spiral spring.

7. The drive and turning device as claimed in claim 4, wherein the actuating part is embodied in a sleeve-shaped manner, an end portion of the sleeve-shaped actuating part being non-rotatably connected to the free-running element and the actuating part having in its opposing end portion an abutment pin for engaging with the abutment element.

8. The drive and turning device as claimed in claim 7, wherein the abutment pin, viewed from the side, is arranged on the actuating part so as to protrude axially on the end side.

9. The drive and turning device as claimed in claim 4, wherein the free-running element, which is mounted so as to be able to rotate about the axis of rotation of the drive shaft, is embodied in a substantially disk-shaped manner and has on its outer circumferential surface a guide groove in which a sliding part, which is arranged in the Venetian blind bearing so as to be linearly movable, is guided.

10. The drive and turning device as claimed in claim 9, wherein the guide groove runs helically and is embodied in an end portion as a peripheral guide channel without an inclination in order to ensure a free run for the sliding part in a direction of rotation.

11. The drive and turning device as claimed in claim 4, wherein the rotary movement of the drive shaft is transmitted to the free-running element of the actuating mechanism by means of a planetary gear.

12. The drive and turning device as claimed in claim 4, wherein at least the actuating mechanism is arranged and embodied in a separate bearing part which is releasably connectable to a bearing housing.

13. The drive and turning device as claimed in claim 1, wherein the abutment element of the turning mechanism is embodied in a disk-shaped manner, a stop element for engaging with the abutment flange and means for engaging with the actuating part of the actuating mechanism being arranged or embodied on the side of the abutment element that is remote from the turning element.

14. The drive and turning device as claimed in claim 13, wherein the means is formed by a guide track in which the actuating part is guided.

15. The drive and turning device as claimed in claim 14, wherein the guide track is embodied as an arc of a circle-shaped through-opening.

16. The drive and turning device as claimed in claim 2, wherein the actuating element can be brought by means of the sliding part of the actuating mechanism into operative connection to the abutment element of the turning mechanism.

17. The drive and turning device as claimed in claim 16, wherein at least the winding spool, the turning mechanism, the abutment flange and the actuating element are arranged in a common bearing housing.

18. The drive and turning device as claimed in claim 17, wherein the bearing housing, which has at least the winding spool, the turning mechanism, the abutment flange and the actuating element, is releasably connectable to the bearing part having the actuating mechanism.

19. The drive and turning device as claimed in claim 2, wherein the actuating element is movable between an engagement position, arresting the abutment element in an angular intermediate position, and a release position.

20. The drive and turning device as claimed in claim 2, wherein the actuating element has a basic element and at least two engagement elements which are arranged thereon and of which a first engagement element is operatively connected or can be brought into operative connection to the turning mechanism and/or a second engagement element is operatively connected or can be brought into operative connection to the actuating mechanism.

21. The drive and turning device as claimed in claim 20, wherein the actuating element can be moved between the release and engagement positions by converting a rotational movement of the drive shaft into an axial movement in the direction of the axis of rotation.

22. The drive and turning device as claimed in claim 20, wherein the actuating element is free from the loading of a force accumulator, in particular spring loading, at least during the movement between the release and engagement positions, and vice versa.

23. The drive and turning device as claimed in claim 2, wherein the actuating element is arranged in the bearing housing so as to be movable substantially parallel to the axis of rotation, the actuating element being moved between the release and engagement positions by means of the turning mechanism.

24. The drive and turning device as claimed in claim 23, wherein the actuating element is arranged in the bearing housing so as to be able to swivel substantially parallel to the axis of rotation.

25. The drive and turning device as claimed in claim 24, wherein the actuating element is mounted on the bearing housing so as to be able to swivel about an axis which is substantially normal to the axis of rotation.

26. The drive and turning device as claimed in claim 23, wherein the actuating element is arranged in the bearing housing so as to be displaceable linearly, substantially parallel to the axis of rotation.

27. The drive and turning device as claimed in claim 23, wherein a guide element, by means of which the actuating element is guided so as to be linearly displaceable in a corresponding guide embodied on the bearing housing, is arranged or embodied on the actuating element.

28. The drive and turning device as claimed in claim 27, wherein the guide is formed by a through-opening formed in the wall of the bearing housing.

29. The drive and turning device as claimed in claim 2, wherein the abutment element of the turning mechanism is embodied in a disk-shaped manner and has on its outer circumferential surface at least one deflecting element and an arresting element which interact with the actuating element.

30. The drive and turning device as claimed in claim 29, wherein the arresting element is embodied in a v-shaped manner.

31. The drive and turning device as claimed in claim 29, wherein the actuating element is driven during its movement between the release and engagement positions by means of a wheel and shaft, the shaft of the wheel and shaft being formed by the drive shaft and the wheel of the wheel and shaft being formed by the abutment element of the turning mechanism and the rotational movement of the abutment element being converted into an axial movement of the actuating element in the direction of the axis of rotation substantially by means of the at least one deflecting element arranged on the circumferential surface of the abutment element.

32. The drive and turning device as claimed in claim 1, wherein the abutment flange is embodied, as is known per se, for receiving a plurality of abutment pins in different site positions, the different site positions each defining different angular end positions.

33. A Venetian blind with a drive and turning device as claimed in claim 1, characterized by a raising working position for the slats during raising of the Venetian blind, in which the slats are arrested or arrestable in an angular intermediate position positioned between two angular end positions.

34. The Venetian blind as claimed in claim 33, characterized by at least two working positions for the slats, of which a first, lowering working position can be assumed during lowering of the Venetian blind and said raising, second working position can be assumed during raising of the Venetian blind, the two working positions being fixed by two different angular intermediate positions positioned between the two angular end positions.

35. A method for swiveling the slats of a Venetian blind as claimed in claim 33, in which the slats are arrestable during raising of the Venetian blind in an angular intermediate position positioned between two angular end positions, wherein during raising of the Venetian blind from the lowered position the slats
a) are in a first step turned inward until
b) the free-running element of the actuating mechanism is blocked by means of the sliding part, as a result of which the direction of rotation of the sun wheel of the planetary gear is reversed and, on further rotation of the drive shaft,
c) the turning element is moved via the coupling element and the actuating part, which is engaged with the abutment element, in a direction of rotation opposite to the direction of rotation of the drive shaft until
d) the actuating part is blocked in the bearing part, as a result of which,
e) on further rotation of the drive shaft, the slats are swiveled into the second angular intermediate position and remain therein until the next reversal of the direction of rotation of the drive shaft.
